(19) United States
(12) Patent Application Publication
(10) Pub. No.: US 2008/0025877 A1
(43) Pub. Date: Jan. 31, 2008

(54) Specimen collection and testing apparatus

(76) Inventor: Kenneth A. Alley, Tampa, FL (US)

Correspondence Address: LAW OFFICES OF MARK A. GARZIA, P.C., 2058 CHICHESTER AVE, BOOTHWYN, PA, 19061, US

(21) Appl. No.: 11/803,427

(22) Filed: May 15, 2007

Related U.S. Application Data
(60) Provisional application No. 60/800,273, filed on May 15, 2006.

(51) Int. Cl. B01L 3/00

(52) U.S. Cl. 422/102

(57) ABSTRACT

A specimen collection and testing unit is provided for use in the collection, exact volume extraction and delivery of said exact volume for testing with a reagent. The specimen collector may include a scoop/mechanism having a flexible head that flips from a concave shape (for scooping specimen) to a convex shape to ensure the exact amount of specimen is being treated.

### CROSS REFERENCE TO RELATED APPLICATIONS

The present application claims the benefits under 35 U.S.C. § 119(e) of U.S. Provisional Application No. 60/800,273 filed May 15, 2006, titled STOOL SPECIMEN COLLECTION AND TESTING APPARATUS, in the name of Kenneth A. Alley.

U.S. Provisional Application No. 60/800,273 filed May 15, 2006, is hereby incorporated by reference as if fully set forth herein.

### FIELD OF THE INVENTION

This invention relates generally to a specimen collection and testing apparatus and, more particularly, to a specimen collection and testing apparatus having an integrated specimen volume control and dispensing mechanism.

### BRIEF DESCRIPTION OF THE PRIOR ART

Specimen collection devices are well known in the industry. These include stool specimen collection tubes, containers, vials and/or swabs that may incorporate reagents and dispensing means. With a typical specimen collection apparatus, a collection container is given to a patient for stool samples. The patient fills the container with a specimen then returns the collection container to the laboratory. The specimen is then tested in the laboratory.

Typically, the technician opens the container and removes a small portion of the specimen, placing the specimen into a test tube to perform various types of tests. In some cases, the test assays require a very specific amount of specimen to be tested. The lab technician must weigh the specimen or use precision equipment to measure the exact amount of the required specimen before he began testing the specimen.

In addition to collection containers returned to a lab, there are a number of specimen test kits that include reagents and dispensers. These kits typically provide a swab that mixes with a reagent. For example, U.S. Pat. No. 5,879,635 describes a “reagent dispenser and related test kit for biological specimens.” The '635 patent discloses the use of a swab along with reagents. The swab is used to collect a specimen such as stool, and by breaking the membrane a reagent is mixed with stool sample for later dispensing. Another example is U.S. Pat. No. 5,266,266 which describes a specimen test unit. This particular device also discloses the use of a swab along with some reagents. The swab is used for collecting a selected specimen for later testing and dispensing.

There are numerous tests that require a specific or predetermined amount of specimen, and therefore the lab technician needs to handle the specimen in order to weigh it or measure it to perform the test. Needless to say, handling these biological specimens is undesirable and great caution must be used.

As previously mentioned, both of the aforementioned patents provide a swab that is incorporated into a tube along with the reagent. In some cases, the technician may simply dispense the reagent/specimen sample to perform a test. Although, in many cases the testing assays require a predetermined and or a specific amount of specimen in order to perform the biological test. The prior art does not provide the ability to precisely control the amount of specimen collected, therefore, these devices cannot be used for a test where a quantitative sample is required. Such a test requires well-trained technicians to handle the specimens and perform the test.

Additionally, there are numerous biological tests that could be performed by a consumer, thus lowering the cost of medical care if there was a device that had the ability to accurately control the specimen collected with the given a reagent. In order to sell over-the-counter biological testing devices, they must be deemed easy to use and have the ability to meet specific guidelines, with regard to function simplicity and accuracy.

### SUMMARY OF THE INVENTION

The testing apparatus includes the means to control a predetermined or required amount of specimen for specific test. The collection and testing apparatus includes an upper section and a lower section. The upper section is designed to receive a specimen by utilizing a scoop, applicator and or a specialized plunging/scoop mechanism. The lower section is designed to incorporate a reagent and or reagents. Between the upper section, and the lower section of the apparatus, there is a port which is designed to receive an interchangeable plug. The plug is designed to close off the lower section from the upper section and simultaneously communicate with both the upper and lower sections. Specifically, the specialized plug incorporates a cavity (predetermined volume) that is mated with the upper section of the apparatus. When a specimen is put into the upper section of the apparatus, the predetermined cavity on the plug will be filled with a predetermined and controlled amount of the specimen. The specialized plunging mechanism will force any type of solid specimen into the cavity thus assuring that the cavity of the plug is filled appropriately. The specialized plug may then be rotated or moved to align the cavity containing the specimen adjacent to the lower section, thereby mixing the specimen with a reagent. The lower section of the device may include a dropper tip for dispensing the controlled test portion mix (specimen/reagent) required for a specific test.

The subject invention provides the means to precisely control the amount of specimen required for any given test. The invention also provides a collection device with means to isolate and mix a predetermined amount of specimen with a reagent and dispense it without having to re-open the collection container. More specifically, the following invention is a Specimen Collection and Testing Apparatus with an Integrated Specimen Volume Control and Dispensing Mechanism which is designed to be used in both vivo and vitro environments.

The present invention is a collection and or testing apparatus which includes an integrated and interchangeable specimen volume control means and a reagent/specimen dispensing mechanism. The testing apparatus includes the means to control a predetermined amount of a specimen for specific test. The collection and testing apparatus may include an upper section and a lower section. The upper section is designed to receive a specimen by utilizing a scoop, applicator and or a specialized plunging/scoop mechanism. The lower section is designed to incorporate a reagent and or reagents. Between the upper section, and the lower section of the apparatus, there is a port which is designed to receive an interchangeable and rotatable (i.e., movable) plug. The specialized plug is designed to close off both; the interior openings of the lower section from the upper section and simultaneously communicate with both the upper section and lower sections. Specifically, the specialized plug incorporates a predetermined cavity that is mated with the upper section of the apparatus. When a specimen is put in the upper section of the apparatus the predetermined cavity on the plug will be filled with a predetermined and controlled amount of the specimen. The specialized plunging/scoop mechanism will force any types of solid/liquid specimen into the cavity thus assuring that the cavity of the plug is filled appropriately. The specialized plug may then be rotated or moved to align the cavity with the adjacent or lower section, thereby mixing the specimen with a reagent. The lower section of the device may include a dropper tip for dispensing the controlled test portion required for specific tests. The dropper tip in the lower section could be replaced or adapted to fit a testing cassette or other devices which may be desired (such as a swab, a test cassette with test strips etc).

The apparatus disclosed herein could be used as a collection device, testing device, or any combination, depending on the particular application. One of the applications would be to make a test specific device, thus, providing the entire test platform, via assay, in a single device which may be used over the counter, and/or in a laboratory environment.

The subject apparatus is especially well-suited for use as a (stool or specimen) collection container. Typically, stool collection containers include a container and a scoop. The patient collects a stool sample and sends it to the physician's office and/or laboratory where it is later tested for various pathogens and/or agents. A lab technician must then open the container and utilizing another applicator and/or swab, remove a portion of the specimen to be tested. As previously mentioned, some tests require specific amounts of specimen to be utilized. Therefore, the technician would need to weigh it or precisely measure the specimen. (Note: tests that require precise and or specific amounts of a specimen are typically deemed to be too complicated for public use and therefore are not usually sold over-the-counter.)

If the present apparatus (invention) were used in place of standard collection containers, the interchangeable, predetermined plug cavity could be adapted to the apparatus for specific tests prescribed by the physician. When the technician is ready to perform the test, they simply rotate and/or move the interchangeable plug to align the cavity containing the measured specimen with the adjacent chamber. The adjacent chamber could include a reagent and or reagents that would automatically mix with the specimen. The specimen-reagent mix could then be dispensed into test cassettes or other test platforms. The adjacent chamber could also remain empty so that the technician could use it for any numerous tests that are later to be determined. In this case, the technician would never need to open the apparatus, but instead simply rotate or manipulate the movable plug to an adjacent chamber. With slight modifications, the described apparatus could be adapted to existing specimen collection containers such as stool collection containers and blood vacuum tubes. There are numerous applications for such an apparatus, including but not limited to biological (saliva, urine, stool, etc) and environmental testing.

One of the main benefits of the described apparatus is that the plug can be interchanged with alternate plugs that incorporate different volume cavities. This feature would allow the device to be used for specific platforms (by color coding the plugs during manufacturing for different uses). The plug could also be used as a bypass (open/closed) closing off the upper section from the lower section and when desired, by manipulating the plug (opening) so that the upper section may communicate directly with the lower section thereby, mixing multiple reagents and/or specimens. The plug cavity could also be designed to incorporate reagents.

Another important feature of the present apparatus is that either the upper and/or lower sections could be adapted to incorporate various types of applicators including a swab with and/or without a dropper. A typical test cassette could also be incorporated into either section of the apparatus.

The described apparatus could also include a plug with multiple cavities adjacent to one another, and multiple lower sections. The cavities in the lower sections may or may not be isolated from one another. That would depend on the particular application. Although, the described apparatus includes an upper section, along with the lower section, it is conceivable that there are applications where the lower section is replaced with an adjacent section and the movable interchangeable plug is pushed (or twisted) horizontally instead of rotated (moving the cavity vertically). This particular configuration could be adapted as a top cover for a typical test cassette. There are numerous combinations and/or configurations that could be incorporated in to the described invention.

### BRIEF DESCRIPTION OF THE DRAWINGS

The foregoing summary, as well as the following detailed description may be better understood when read in conjunction with the accompanying drawings, which are incorporated in and form a part of the specification. The drawings serve to explain the principles of the invention and illustrate embodiments of the present invention that are preferred at the time the application was filed. It should be understood, however, that the invention is not limited to the precise arrangements and instrumentalities shown.

In the drawings:

FIG. 1 is an isometric view of a specimen collection and testing apparatus in accordance with the present invention. In this particular view the plunging/scoop mechanism is only partially seated in the device.

FIG. 2A is an exploded side view of the special plunging/scoop mechanism. Additionally, the plug is shown with the cavity aligned with the upper section of the apparatus. In this particular view the plunging/scoop is in a static position. When the closure of the upper section is completely tightened, the plunger/scoop will be flexed from its concave shape towards more of a convex shape thus, remaining in a dynamic position as shown in FIG. 2B.

FIG. 2B is an exploded front view of the plunging mechanism and the plug cavity feature of the device. In this particular view, the plunging/scoop mechanism is pushed completely downward (in a dynamic position). In this particular view, the cavity of the plug is filled with the specimen and the excess specimen is shown in the upper chamber displaced around the plunging/scoop mechanism.

FIG. 3 is a perspective isometric view of an alternative embodiment of a specimen and collection and testing apparatus in accordance with the present invention. In this particular design, the movable plug communicates with the upper and lower section of the apparatus by moving horizontally. Instead of rotating the plug, as in FIG. 1, this particular plug is designed to move horizontally thus, communicating with both upper and lower sections of the apparatus.

FIG. 4 is an isometric view of an alternative apparatus. In this particular design, the rotate able or movable plug is designed to move horizontally by twisting the plug. Similar to the apparatus in FIG. 3, the upper section and the lower sections both have respective openings that are designed to communicate with a plug, although, in this case the plug is aligned to the respective openings by mechanically being rotated or twisted horizontally.

FIG. 5 is a perspective exploded side view of the specialized plug with the cavity (predetermine volume) described in the apparatus of FIG. 1. The plug incorporates a cavity with a predetermined volume control that is designed to be filled with a specimen. As described in the apparatus of FIG. 1, the specimen will be compressed into the cavity of the plug. When the plug is rotated within its port or housing, the excess specimen is wiped clean from the surrounding areas. Once the cavity is positioned or aligned to the lower chamber, the contents of the cavity will be exposed to the contents of the lower section of the apparatus. In this position the desired testing can take place.

Additionally, the apparatus described in FIG. 1 could incorporate multiple cavities (each of a predetermined volume). Once the plug is rotated, the multiple cavities would simultaneously be repositioned from one chamber to a secondary chamber. The secondary chamber could also include multiple chambers isolated from one another. Each of these chambers may include reagents unique to a specific test.

FIG. 6 represents a side view of an alternative plug. In this particular example, the plug is designed to be pushed horizontally. This particular plug also includes a cavity (which also provides a closed off position) and it includes an open bypass. This particular plug could be utilized for blood collection tubes. More specifically, if a blood vacuum tube incorporated such a plug feature, the plug could be used to isolate blood serum from the blood cells. Some of these applications will be discussed later.

FIG. 7 is a front view of the apparatus described in FIG. 1. In this particular illustration, the plunging/scoop mechanism has been replaced with a swab or spooned style scoop and the lower section is open ended and can be used to be adapted to additional devices. This particular configuration could be used to replace the existing stool collection containers. A patient would fill the chamber with a specimen and send it to the physician's office. All the physician or technician would need to do, is rotate the plug with the cavity (predetermine volume) to access the specimen for testing.

It should be noted that, after reading the present disclosure, a person skilled in the art could adapt certain novel features of the present invention into existing stool collection containers. By incorporating the plug/port and cavity feature/mechanism into a closure along with the plunging mechanism, a typical stool collection container could be utilized to take advantage of the invention described in FIG. 1.

FIG. 8 is an alternative concept of a diagnostics swab/applicator holder and dispenser. The unique feature of this diagnostics swab/applicator is that the applicator includes a dropper tip dispenser within the swab handle. Unlike existing swab applicators this particular applicator incorporates a dropper tip that becomes the swab or applicator holder. It also may include a moldable filter and an over cap (or one piece flip top cap) that seals the entire contents of the swab and the test tube (or device) that it is adapted to. One of the unique benefits of this design is that the diagnostic swab applicator in FIG. 8 could be incorporated onto a closed-end test tube and still provide the means to dispense the specimen without removing the applicator after its been contaminated with a specimen.

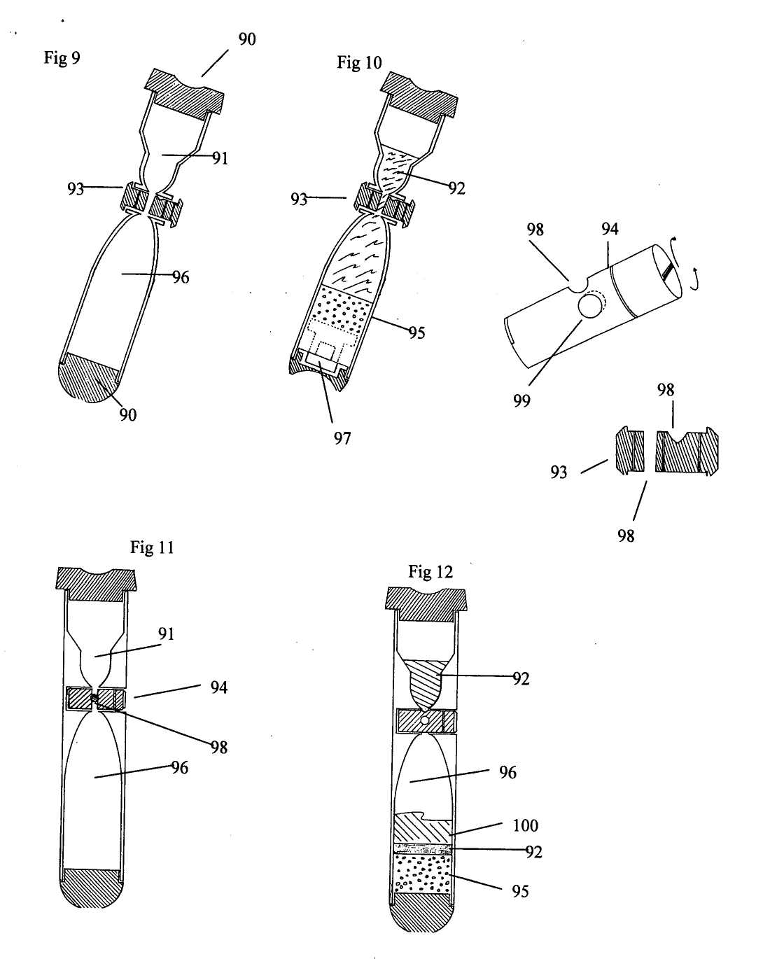

The diagnostic swab/applicator holder and dispenser described in FIG. 8 could also be incorporated and or adapted to the described invention. The apparatus shown in FIG. 7 could include the “diagnostic swab applicator holder and dispenser” onto the lower section and or the upper section of the device. This particular design could be incorporated into numerous devices.

The prior art applicator or swab holders do not have the ability to also dispense the specimen. For example: as previously mentioned in U.S. Pat. No. 5,879,635 which describes a “reagent dispenser and related test kit for biological specimens” the applicator or swab holder does not incorporate means to dispense the specimen and reagent mix. In order to dispense the specimen mix there is a dropper tip at the opposite end of an open ended tube. The alternative concept described in FIG. 8, would provide the means to dispense the specimen/reagent mix through the applicator holder and could be adapted to closed-ended test tubes that are commonly used today, or the concept could be adapted to the apparatus described in this invention.

FIG. 8B is an alternative concept of a dispenser/closure with a swab/applicator holder and a molded filter. The unique feature of this dispenser is that it includes a molded filter that communicates with an applicator to control the diameter of the dispensing exit port. It also holds and aligns the applicator (or diagnostics swab/applicator).

FIGS. 9, 10, 11, 12 are perspective front views of and alternative application of the apparatus described in FIG. 1, where the apparatus is used as a blood vacuum tube. Typical blood vacuum tubes are used to drawl the blood out of the person's veins. Once the blood is drawn, the blood serum is typically separated from the blood cells by using a centrifuge. One of the problems is that the serum does not stay separated from the blood cells for long periods of time. There are density barriers that are added into typical blood tubes, although these are not permanent either. By incorporating the plug described in FIGS. 9, 10, 11 and 12 the upper section of the blood vacuum tube apparatus could be closed off from the lower section of the after the blood serum is separated. The plug in FIGS. 9 and 10 are designed to be pushed horizontally and the plug described in FIGS. 11 and 12 are designed to be rotated.

Another added advantage of incorporating a movable plug into vacuum tube containers is that there are numerous analytical analyzers/equipment that could automatically access the upper section of the container. By incorporating a small cavity into the plug along with a bypass, a needle can enter through the upper section and retrieve a specified amount of specimen to be tested. Additionally, by incorporating a plug and transfer mechanism for use with vacuum tubes there would be no need to pour off the serum specimen into alternative tubes and it would be less likely mix up or lose the specimen containers. Also, by incorporating the movable plug with either a bypass and/or cavity into the vacuum tube, the original sample is always available when needed. And there is no need to pour off serum samples into additional containers. This could provide a cost savings and a logistical advantage in handling specimens.

### DETAILED DESCRIPTION OF THE PREFERRED EMBODIMENT

Referring now to FIG. 1, an isometric view of the described claimed invention/apparatus is shown. Specimen collection and testing apparatus 10 includes an upper section 14, and lower section 9. It will be appreciated that certain terms (e.g., upper, lower, left and right) are used when viewing the drawings for the sake of clarity and are not meant to be taken literally). Between the upper and lower section of apparatus 10, there is a receptacle 5 that is designed to receive a plug 6. Receptacle 5 includes opening 18 to the upper section 14, and opening 8 to the lower section 9. The specialized plug 6 is designed to close off upper section 14, from lower section 9. Additionally, plug 6 is designed to communicate with both the upper section 14 and lower section 9 of the apparatus 10. Plug 6 includes cavity 7 (with a predetermined volume control). When plug 6 is placed into receptacle 5, cavity 7 is aligned with the upper section 14 and frictionally sealed with the upper opening 18 of receptacle 5. Simultaneously, the lower section opening 8 of receptacle 5 is also closed and frictionally sealed off from lower section 9.

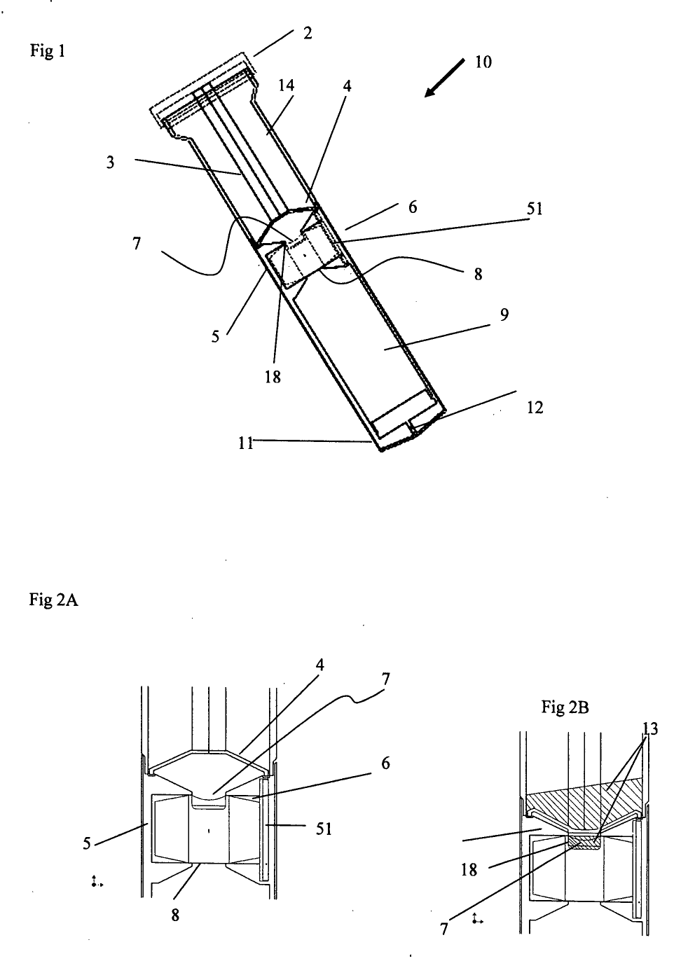

Apparatus 10 also includes a dispensing tip 12 and an outer cover or closure 11. The upper section of device 10 is adapted to receive closure 2. Closure 2 includes applicator shaft 3 and plunging scoop mechanism 4. The plunging/scoop mechanism 4 is designed to perform two functions, first it is used to collect a specimen; and second, it is designed to deliver the specimen into the upper section 14 and eventually compress a portion of the specimen into cavity 7. Plunging/scoop mechanism 4 may be made of a flexible material, such that the flexible plunging/scoop mechanism may be concave shape as illustrated in FIG. 2A, to scoop up a stool specimen, and then flips to a convex shape to ensure the compression of the specimen into cavity 7, as illustrated in FIG. 2B.

For example, when the specimen is placed into upper section 14 of apparatus 10 and the closure 2 is securely attached to the upper section's open end, the plunging/scoop mechanism 4 will be forced downward thus, compressing the specimen between the plunging/scoop mechanism and into the aligned cavity 7 of plug 6. The plunging/scoop will be flexed from a concave shape to a convex shape and will be fully seated against the bottom of the upper section 14 once the closure is completely attached to apparatus 10. As a result of this action, cavity 7 of plug 6 will be filled with a predetermined and controlled amount of the specimen. Note: The specialized plunging/scoop will force any type of solid/liquid specimen into cavity 7 thus; insuring that cavity 7 is filled appropriately. Any excess specimen will be vented around the plunging scoop (i.e., towards the closure 2). Depending on the specimen, additional venting could be adapted to the device.

Plug 6 may be adapted with a finger grip 17 or a slot 51 for receiving a flat-head screwdriver. The finger grip 17 or screwdriver slot assists a user in rotating the plug once the specimen has been compressed into cavity 7. Once the cavity 7 is filled with the specimen, plug 6 may then be rotated or moved to align cavity 7 with the adjacent or lower section receptacle opening 58, thereby mixing the specimen with a reagent that may be stored in the lower section 9.

The lower section may include a dropper tip 12 for dispensing the controlled test portion required for specific tests. The dropper tip in the lower section could be replaced, or adapted to fit a testing cassette or other devices which may be desired such as, the swab described in FIG. 8. It is important to note that plug 6 prevents any reagent from escaping into the upper compartment and simultaneously prevents any additional specimen from entering the lower compartment.

FIGS. 2A and 2B illustrate an exploded side view of the plunging/scoop mechanism 4. Additionally, the plug 6 is shown frictionally engaged into receptacle 5 with cavity 7 aligned with the upper section of the apparatus. Plug 6 closes off or isolates the lower section from the upper section.

In FIG. 2A, the plunging/scoop 4 is in a static position. When closure 2 is completely tightened, the plunger/scoop 4 will be flexed from its concave shape towards more of a convex shape thus, remaining in a dynamic position as shown in FIG. 2B.

Referring again to FIG. 2B, the scoop mechanism 4 is shown in its convex position. Plug 6 is still in its initial state in which cavity 7 is in position to receive the specimen. In this particular view, the plunging/scoop mechanism 4 is pushed completely downward (in a dynamic position). Cavity 7 is filled with the specimen 13 and the excess specimen is shown in the upper chamber displaced around the plunging/scoop mechanism. The plunging/scoop mechanism 4 is also fully seated against the upper receptacle opening 18 thus, sealing and compressing the specimen within cavity 7.

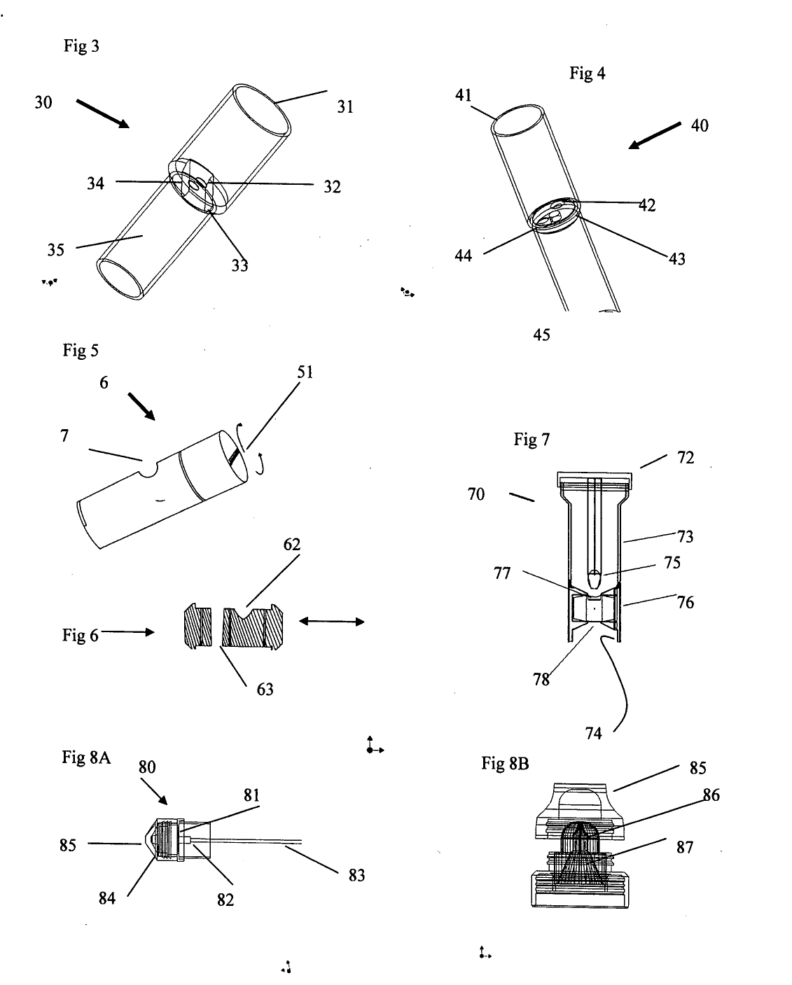

Referring now to FIG. 3, a perspective view of another embodiment in accordance with the present invention. Apparatus 30 includes upper section 31 and lower section 35. In this particular design, the movable plug 33 communicates with the upper and lower section of the apparatus via cavity 32. The size of well 32 determines the amount of specimen to be tested, (i.e., cavity 32 is analogous to cavity 7 of plug 6). Lower section 35 is substantially closed at the end proximate plug 33, except for opening 39. When a specimen is placed into the upper section 31, plug 33 closes off upper section 31 from lower section 35. When plug 33 is moved horizontally, well 32 aligns with opening 39 thereby plug 33 transferring the specimen within the well to the lower section 35. Instead of rotating the plug, as in FIG. 1, this particular plug is designed to move horizontally thus, communicating with both upper and lower sections of the apparatus.

Referring now to FIG. 4, an isometric view of another preferred embodiment is shown. Apparatus 40 includes upper section 41 and lower section 45. In this particular design, a movable plug 43 communicates with the upper and lower section of the apparatus 40. When a specimen is placed into the upper section 41, plug 43 closes off upper section 41 from lower section 45. In this embodiment, lower section 45 is closed proximate the plug 43 except for opening 39. When plug 43 is twisted in a circular motion horizontally (similar to a lipstick tube), plug 43 transfers the specimen within its cavity 42 to align with opening 39 deliver the specimen to the lower section 45. Similar to the apparatus in FIG. 3, the upper section and the lower sections both have respective openings that are designed to communicate with a plug, although, in this case the plug is aligned to the respective openings by rotating the plug radially (twisting in the horizontal plane).

Referring to FIG. 5 a perspective exploded side view of the specialized plug 6 described in the apparatus of FIG. 1 is shown. Plug 6 incorporates cavity 7 (with a predetermined volume control) which is designed to be filled with a specimen. As described in the apparatus of FIG. 1, the specimen will be compressed into cavity 7 of the plug. When the frictionally sealed plug 6 is rotated within its receptacle (or housing) 5, the excess specimen is wiped clean from the surrounding areas. Once the cavity is positioned or aligned with the lower (or an adjacent) section, the contents of the cavity will be exposed to the contents of the lower section of the apparatus. In this position the desired testing can take place.

Additionally, plug 6 could incorporate multiple cavities (each with predetermined volumes). Once the plug is rotated, the multiple cavities would simultaneously be repositioned from one chamber to a secondary chamber. The secondary chamber could also include multiple chambers isolated from one another. Each of these chambers may include reagents unique to a specific test.

The testing apparatus is accordance with the present invention can be shipped with different plugs 6, each having a different size well. The selection of plug 6 will be determined by the type of test. The manual manipulation of the plug 6 along with a pre-determined sized well 7 will deliver a precise amount of specimen to the secondary chamber.

Referring to FIG. 6, a side view of an alternative plug is shown. In this particular example, the plug is designed to be pushed horizontally. This particular plug also includes cavity 62 (which can also be used as a shut off feature) and an open bypass 63. This particular plug could be utilized for blood collection tubes. More specifically, if a blood vacuum tube incorporated such a plug feature, the plug could be used to isolate blood serum from the blood cells.

Referring to FIG. 7, a front view of an alternative apparatus is described. In this particular illustration, apparatus 70 includes closure 72. The plunging/scoop mechanism described in FIG. 1, has been replaced with a swab or spooned style scoop 75. The lower section is open-ended and incorporates attachment means 74 that can be used to connect additional devices to apparatus 70.

By replacing swab 75 with the plunging/scoop mechanism 4 described in FIG. 1, this particular configuration could be used to replace the existing stool collection containers. For example, a patient would fill the upper chamber 73 with a specimen. The plunging scoop mechanism described in FIG. 1, would fill cavity 77. The entire specimen container could then be sent to the physician's office. The physician or technician would need only rotate plug 76 transferring the specimen to the open-ended section 78 providing access for further testing.

U.S. Pat. No. 5,266,266 to Mason and U.S. Pat. No. 5,879,635 to Mason are hereby incorporated by reference as if fully set forth herein.

There are numerous configurations that could be incorporated into an alternative device. The upper section could be used for receiving a solution or storing a reagent and the lower section could be used to obtain a sample specimen by means of a swab or applicator. By interchanging components in either the top section or lower section, along with various types of plugs, the apparatus could be used for numerous applications.

Additionally, the invention described in FIG. 1, could be adapted to fit onto existing stool collection containers. By incorporating the plug/port and cavity feature/mechanism into a closure along with a plunging mechanism, a typical stool collection container could be utilized to take advantage of the invention described in FIG. 1.

FIG. 8A discloses another embodiment in accordance with the present invention. In this Figure, a diagnostics swab/applicator holder is shown. A unique feature of the diagnostics swab/applicator 80 is that the applicator includes a dropper tip dispenser 84. Applicator 80 may also include a moldable filter 81 and swab connector 82 (where a typical swab 83 may be frictionally fit). Closure 85 hermetically seals the entire contents of the swab (with or without a specimen) and the test tube (or device) that it is adapted to. One of the unique benefits of this swab/applicator design is that the diagnostic swab/applicator could be incorporated onto a closed-end test tube.

The diagnostic swab/applicator holder and dispenser described in FIG. 8A could be incorporated and/or adapted to the described invention in FIG. 1. Additionally, the apparatus shown in FIG. 7 could include the “diagnostic swab/applicator 80 onto the lower section and/or the upper section of the device.

FIG. 8B is an alternative embodiment of a dispenser tip and closure (one piece system) with a swab/applicator holder and a molded filter. The unique feature of this dispenser/closure is that it includes a molded filter 86 and 87 that extends inward towards the center of the dispensing tip gradually getting smaller. This filter communicates with an applicator (if one is used) to control the diameter of the dispensing exit port. It also holds and aligns the applicator (or diagnostics swab). If an applicator is inserted into the molded filters diameter, the filter gives way to frictionally hold it in place. Depending on the size of the applicator the filter will have to give way more, with respect to a larger applicator. The larger the filter gives the larger the particles may pass through. At the lower section 87, of the molded filter there is a taper to help align the applicator during insertion. The minimum size filtered exit port would be if no applicator was used and then the further the filter was distorted the larger the opening.

The prior art applicators or swab holders do not have the ability to also dispense the specimen. For example, as previously mentioned in U.S. Pat. No. 5,879,635 which describes a “reagent dispenser and related test kit for biological specimens” the applicator or swab holder does not incorporate means to dispense the specimen and reagent mix. In order to dispense the specimen mix there is a dropper tip at the opposite end of an open ended tube. The alternative concept described in FIG. 8, would provide the means to dispense the specimen/reagent mix through the applicator holder and could be adapted to closed-ended test tubes that are commonly used today, or the concept could be adapted to the apparatus described in this invention.

FIGS. 9, 10, 11, 12 are perspective front views of and alternative application of the apparatus described in FIG. 1, where the apparatus is used as a blood vacuum tube. Typical blood vacuum tubes are used to drawl the blood out of the person's veins. Once the blood is drawn, the blood serum is typically separated from the blood cells by using a centrifuge. One of the problems is that the serum does not stay separated from the blood cells for long periods of time. There are density barriers that are added into typical blood tubes, although these are not permanent either. By incorporating the plug described in FIGS. 9, 10, 11 and 12 the upper section 91 of the blood vacuum tube apparatus could be closed off from the lower section 96 after the blood serum is separated from the whole blood. Plug 93 shown in FIGS. 9 and 10 are designed to be pushed horizontally and plug 94 described in FIGS. 11 and 12 are designed to be rotated.

Another added advantage of incorporating a movable plug feature into vacuum tube containers, is that there are numerous analytical analyzers/equipment that could automatically access the upper section of the container. By incorporating a small cavity 98 into plug 93 along with bypass 99, an extraction needle can enter into the upper section of the vacuum tube and retrieve a specified amount of specimen to be tested. Additionally, by incorporating a plug and transfer mechanism for use with vacuum tubes there would be no need to pour off the serum specimen into alternative tubes and it would be less likely to mix up or lose the specimen containers. Also, by incorporating a movable plug 94 with either a bypass and/or cavity into the vacuum tube, the original sample is always available when needed and there is no need to pour off serum samples into additional containers. This could provide a cost savings and a logistical advantage in handling specimens.

Referring to FIGS. 9 and 10, a specimen container or blood vacuum tube is shown where the red blood cells 95 are separated from the serum 92. At the lower end, there is an expandable closure 97 that may be manually pushed inward forcing the serum through the open bypass in plug 93 and into the upper section 91. Once the serum is in the upper section of the container, the plug may be moved horizontally to shut off the upper section from the lower section. In FIGS. 11 and 12 plug 94, also includes cavity 98 (which can also be used to close the upper section from the lower section) and open bypass 99.

Referring to FIG. 12 a blood collection tube with plug 94 is shown that could be used to replace a typical vacuum tube. For example; after a technician extracts a blood sample from a patient the tube is placed into a centrifuge where the blood serum 92 is separated from the blood cells 95. It is common to put a density barrier 101 into typical blood collection tubes, although the serum and blood cells will eventually re-constitute or combine overtime. By incorporating plug 94, the test tube can be tilted horizontally to allow some of the serum to enter into the upper chamber 92. Once serum is in the upper chamber 92, the plug can be shut thus, isolating the upper chamber with the serum from the lower chamber. If more serum is required in the future plug 94 can be reopened to add additional serum to the upper chamber. It is also common for analytical equipment to utilize a small needle or pipette to obtain a sample from a small micro tube. By incorporating cavity 98 into plug 93, the serum will remain in the cavity allowing the needle to retrieve the small samples that are available for testing. This replaces the need for commonly used micropipettes-inserts used in the chromatography containers for analytical testing equipment.

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

What is claimed is:

1. A specimen test unit, comprising:
a) a housing having an open end and closed end, the housing being split into a first compartment proximate said open end and a second compartment proximate said closed end, said second compartment communicates with said first compartment via an opening, said second compartment capable of storing a reagent for testing the specimen;
b) a plug positioned in said opening between said compartments that physically isolates and separates said second compartment from said first compartment, said plug having a well for receiving a portion of said specimen;
c) a closure that communicates with said housing for closing said open end of the housing;
d) an elongated scoop mechanism attached to said closure for collecting the specimen and for delivery of at least a portion of the specimen to the well in the plug;
e) the plug being moveable such that while continuing to separate the first compartment from the second compartment, the well delivers a specific amount of specimen to the second compartment.

2. The specimen test unit of claim 1 further comprising a flexible head on the end of said elongated scoop mechanism such that when the head is concave-shaped it assists in scooping the specimen, and when pressure is applied to the scoop mechanism via the closure, the head flips to a convex shape to ensure an exact amount of specimen is delivered to said well.

3. The specimen test unit of claim 1 wherein the plug is moveable by rotation in the axial plane.

4. The specimen test unit of claim 1 wherein the plug is moveable by rotation in the radial plane for delivering the specimen to the second compartment.

5. The specimen test unit of claim 1 wherein the plug is moveable in a horizontal plane for delivering the specimen to the second compartment.

6. The specimen test unit of claim 1 wherein the closure and housing have mating threads and the movement of the scoop mechanism is determined by the twisting of the closure
